(19) United States
(12) Patent Application Publication
(10) Pub. No.: US 2007/0125004 A1
(43) Pub. Date: Jun. 7, 2007

(54) Upper reveal molding snap-in 4-way locator insert

(76) Inventors: Robert Conner, Lenox, MI (US); Eric Pennala, Howell, MI (US); Aaron Robinson, Ortonville, MI (US)

Correspondence Address: CLARK HILL, P.C., 500 WOODWARD AVENUE, SUITE 3500, DETROIT, MI, 48226, US

(21) Appl. No.: 11/295,868

(22) Filed: Dec. 7, 2005

(51) Int. Cl. B60J 5/04

(52) U.S. Cl. 49/502

(57) ABSTRACT

An upper reveal molding is provided for a motor vehicle door frame having a flange and a through-hole. The upper reveal molding includes a molding strip adapted to be coupled to the flange. The upper reveal molding also includes a reveal insert fixedly secured to the molding strip. The reveal insert includes a plurality of retention fingers selectively received within the through-hole and lockingly engageable with the motor vehicle door frame in order to locate the upper reveal molding therealong.

### FIELD OF THE INVENTION

The invention relates to an upper reveal molding for a motor vehicle door frame. More particularly, this invention relates to a reveal insert for locating an upper reveal molding along a motor vehicle door frame.

### DESCRIPTION OF RELATED ART

An upper reveal molding is typically secured to a flange of a motor vehicle door frame and extends along a window opening thereof. The upper reveal molding provides sealing engagement between the door frame and a motor vehicle body when the door is closed. An outside surface of the upper reveal molding is typically a visible component along the motor vehicle exterior. Therefore, the upper reveal molding must have an aesthetically pleasing appearance.

The installation of the upper reveal molding to the motor vehicle door frame involves first coupling the upper reveal molding to the flange of the motor vehicle door and then aligning various slots in the upper reveal molding with corresponding slots in the motor vehicle door frame. Thus, the upper reveal molding must be precisely located relative to the motor vehicle door frame to ensure such slot alignment. Current locating members involve multiple parts, require multiple steps, and are not cost-effective. Thus, it would be desirable to provide a simple, cost-efficient solution for precisely locating an upper reveal molding along a motor vehicle door frame.

### SUMMARY OF THE INVENTION

According to one aspect of the invention, an upper reveal molding is provided for a motor vehicle door frame having a flange and a through-hole. The upper reveal molding includes a molding strip adapted to be coupled to the flange. The upper reveal molding also includes a reveal insert secured to the molding strip. The reveal insert includes a plurality of retention fingers selectively received within the through-hole and lockingly engageable with the motor vehicle door frame in order to locate the upper reveal molding therealong.

According to another aspect of the invention, a reveal insert is provided for locating an upper reveal molding to a motor vehicle door frame having a through-hole. The reveal insert includes a mounting portion adapted to be coupled to the upper reveal molding. The reveal insert also includes a locating portion extending out from the mounting portion. The locating portion includes a plurality of retention fingers received within the through-hole and lockingly engageable with the motor vehicle door frame in order to locate the upper reveal molding therealong.

According to yet another aspect of the invention, a method is provided for locating an upper reveal molding to a motor vehicle door frame, having a flange and a through-hole, utilizing a reveal insert coupled to the upper reveal molding and having a plurality of retention fingers. The method includes the steps of: aligning the plurality of retention fingers of the reveal insert with the through-hole of the motor vehicle door frame; inserting the plurality of retention fingers through the through-hole of the motor vehicle door frame; and locking the plurality of retention fingers into engagement with the motor vehicle door frame to locate the upper reveal molding therealong.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a fragmentary, side view of a motor vehicle including an upper reveal molding secured to a door frame of a rear door;

FIG. 2 is a exploded, side view showing the upper reveal molding for installation to the door frame of the rear door;

FIG. 3 is a perspective view of the upper reveal molding including a reveal insert according to the invention;

FIG. 4 is a perspective view of the reveal insert;

FIG. 5 is a opposing perspective view of the reveal insert including a plurality of retention fingers;

FIG. 6 is a cross-sectional view of the reveal insert being installed along the motor vehicle door frame; and

FIG. 7 is a cross-sectional view similar to FIG. 6 showing the plurality of retention fingers engaging the motor vehicle door frame for fixedly securing the reveal insert therealong.

### DETAILED DESCRIPTION OF THE PREFERRED EMBODIMENT

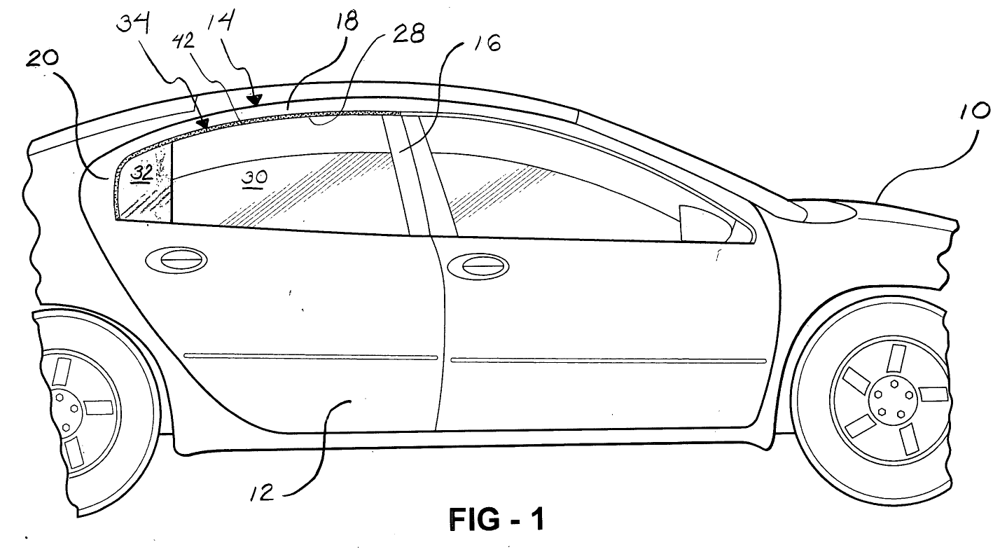

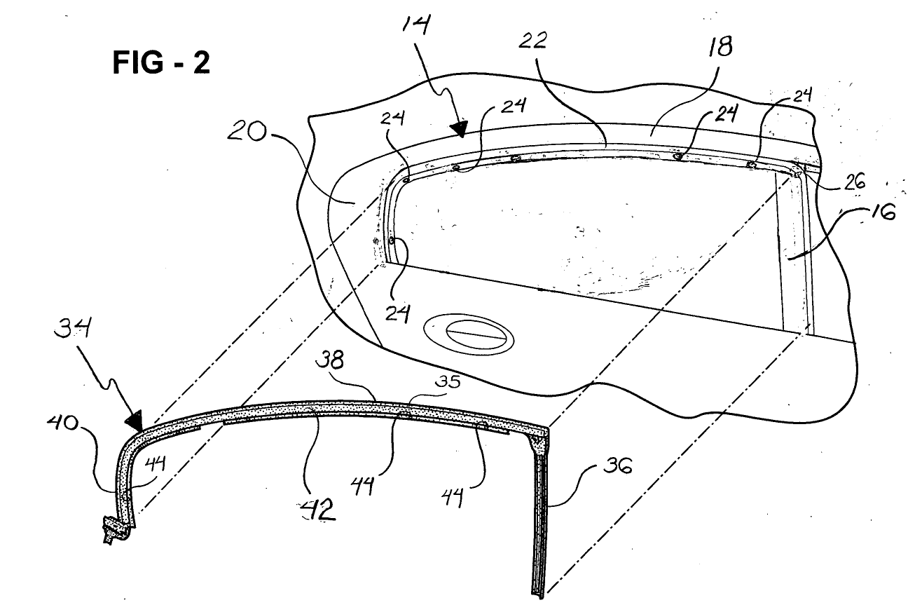

Referring to FIGS. 1 and 2, a motor vehicle 10 includes a rear door 12 having a door frame, generally indicated at 14. The door frame 14 includes a B-pillar 16, a header 18, and a C-pillar 20. A flange 22 protrudes outwardly from the door frame 14 and extends along the B-pillar 16, the header 18, and the C-pillar 20. A plurality of spaced apart mounting holes 24 is formed along the door frame 14 adjacent the flange 22. An enlarged through-hole 26 is formed at one corner of the door frame 14 where the header 18 and B-pillar 16 meet.

The door frame 14 defines a window opening 28, the particular shape of which may vary. A retractable window pane 30 selectively closes a portion of the window opening 28 and a fixed window pane 32 closes a remaining portion of the window opening 28.

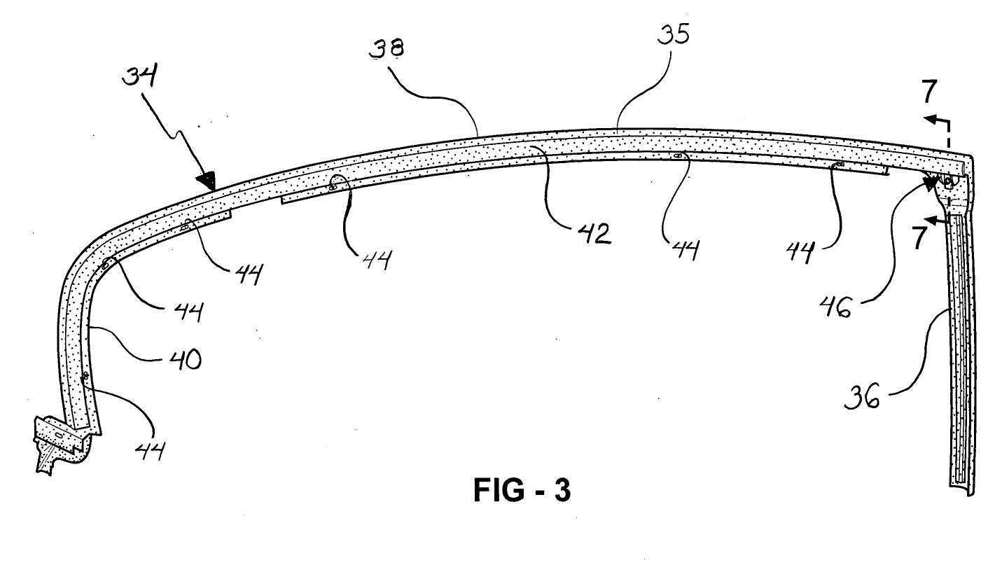

Referring to FIGS. 1 through 3, an upper reveal molding, generally indicated at 34, extends around a portion of the window opening 28 along the B-pillar 16, the header 18, and the C-pillar 20. The upper reveal molding 34 is disposed between the door frame 14 and each of the retractable 30 and fixed 32 window panes. The upper reveal molding 34 includes a molding strip 35 fixedly secured to the flange 22 extending out from the B-pillar 16, the header 18, and the C-pillar 20 of the door frame 14. The molding strip 35 has a B-pillar portion 36 extending along the B-pillar 16, a header portion 38 extending along the header 18, and a C-pillar portion 40 extending along the C-pillar 20. The molding strip 35 also includes a reveal surface 42 that is visible from outside the motor vehicle 10.

The upper reveal molding 34 further includes a plurality of spaced apart slots 44 that aligns with the respective plurality of spaced apart mounting holes 24 when the upper reveal molding 34 is attached along the flange 22. A fastener (not shown) is received through each one of the plurality of spaced apart mounting holes 24 and the respective one of the plurality of spaced apart slots 44 for fixedly securing the upper reveal molding 34 to the door frame 14.

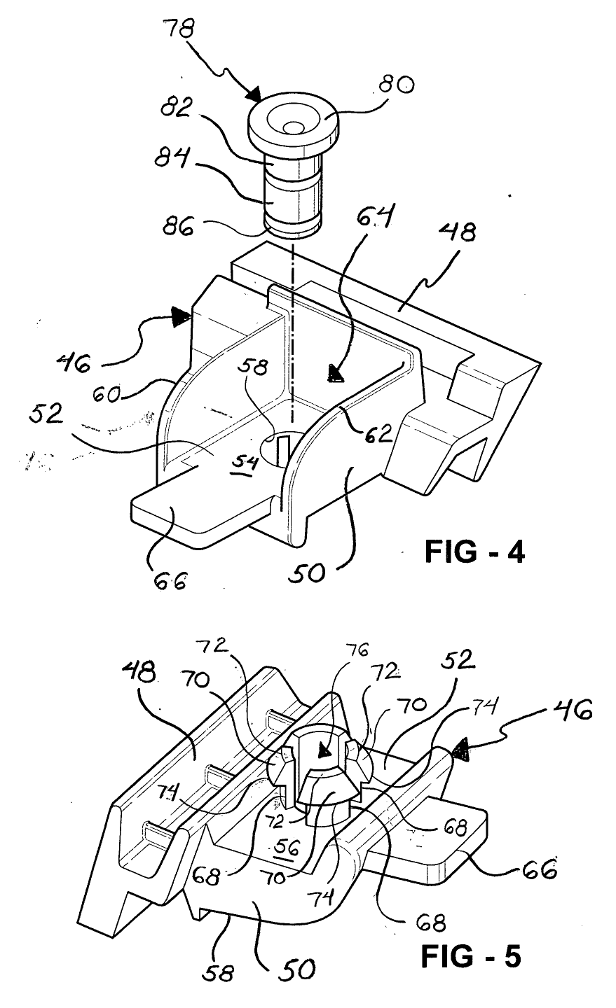

A reveal insert, generally indicated at 46, is coupled to the upper reveal molding 34 for locating the upper reveal molding 34 relative to the door frame 14 in four directions during installation. Referring to FIGS. 4 and 5, the reveal insert 46 includes a mounting portion 48 adapted to be secured to a portion of the upper reveal molding 34. In a preferred embodiment, the mounting portion 48 is bonded to the upper reveal molding 34. It is, however, appreciated that the mounting portion 48 may be secured to the upper reveal molding 34 in any of various ways.

The reveal insert 46 also includes a locating portion 50 extending out from the mounting portion 48. The locating portion 50 includes a base plate 52 having opposing first 54 and second 56 surfaces, and an aperture 58 extending therethrough. A pair of spaced apart outer walls 60, 62 extends out from the first surface 54 of the base plate 52. The pair of spaced apart outer walls 60, 62 defines an access space 64 therebetween. A tab 66 extends out from the base plate 52 away from the access space 64. The tab 66 is utilized to aid installation of the reveal insert 46 to the door frame 14.

Referring to FIGS. 5 through 7, a plurality of retention fingers or prongs 68 extends out from the second surface 56 of the base plate 52. The plurality of retention fingers 68 is received within the through-hole 26 for locking engagement with the door frame 14. In the current embodiment, the reveal insert 46 includes four retention fingers 68. It is, however, appreciated that the particular number of retention fingers 68 may vary. Each of the plurality of retention fingers 68 includes a flexible projection 70 at a distal end. Each of the projections 70 includes a leading end 72 and a secondary end 74. The plurality of retention fingers 68 defines a receiving space 76 that extends between the base plate 52 and the leading end 72 of the projections 70.

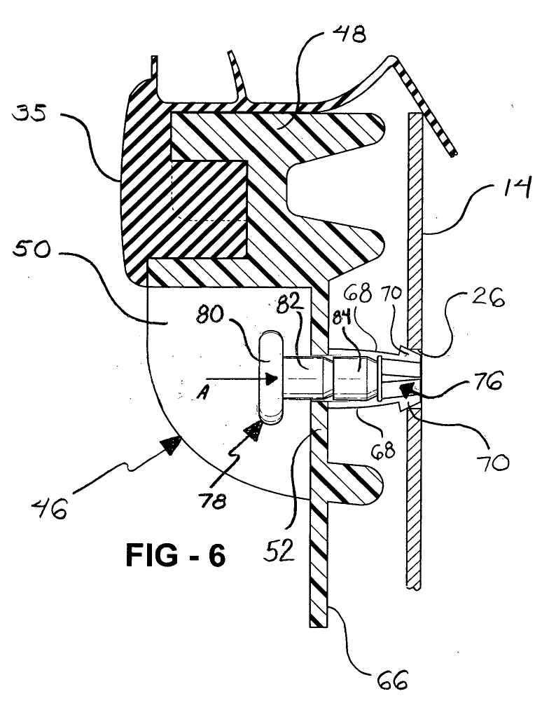

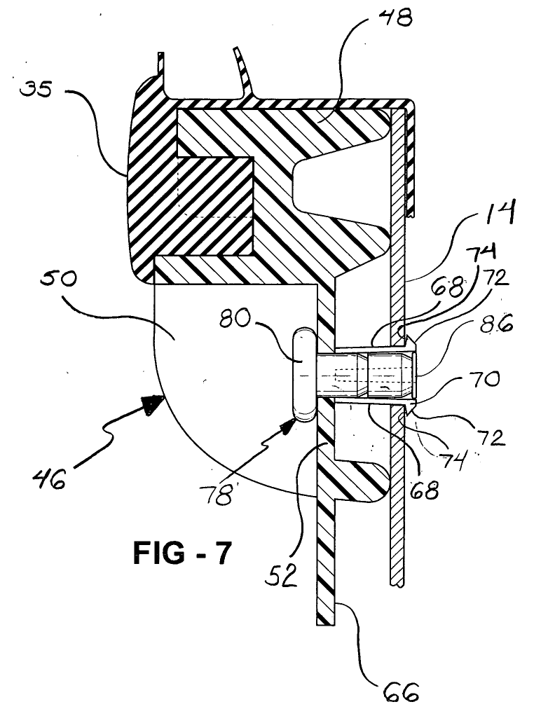

The reveal insert 46 further includes a pin 78 that extends past the aperture 58 and is received within the receiving space 76. The pin 78 includes a head 80 and first 82 and second 84 shaft portions extending out from the head 80. A leading structure 86 extends out from the second shaft portion 84. The pin 78 is held within the receiving space 76 in a partially inserted position, as shown in FIG. 6, due to frictional engagement between the first 82 and second 84 shaft portions and the plurality of retention fingers 68. The partially inserted position is advantageous in that the reveal insert 46 can be shipped as a single piece rather than multiple pieces. When the pin 78 is forced into a fully inserted position, shown in FIG. 7, the leading structure 86 is retained by the plurality of retention fingers 68.

In operation, installation of the upper reveal molding 34 to the door frame 14 begins by attaching a portion of the molding strip 35 to the flange 22 extending out from the door frame 14. Preferably, this initial attachment involves securing a portion of the header portion 38 of the molding strip 35 to a portion of the flange 22 extending along the header 18 of the door frame 14. An operator then grasps the tab 66 of the reveal insert 46 to align the plurality of retention fingers 68 with the through-hole 26 of the door frame 14 such that the leading end 72 of each of the plurality of retention fingers 68 abuts the portion of the door frame 14 around the through-hole 26. The reveal insert 46 is urged in the direction of arrow A, shown in FIG. 6, to insert the projections 70 of each of the plurality of retention fingers 68 through the through-hole 26. More specifically, each of the projections 70 flexes as the reveal insert 46 is urged in the direction of arrow A until the secondary end 74 of each projection 70 extends past the through-hole 26, as shown in FIG. 7. Once the secondary end 74 of each projection 70 clears the through-hole 26 and snaps into locking engagement with the door frame 14, a positive engagement signal is generated to notify the operator that the reveal insert 46 has been installed along the door frame 14. The positive engagement signal may be an audible sound or physical feedback that is felt or sensed by the operator. After the plurality of retention fingers 68 are secured in place, the operator then moves the pin 78 from the partially inserted position, shown in FIG. 6, to the fully inserted position, shown in FIG. 7, where the leading structure 86 is retained by the plurality of retention fingers 68. In the fully inserted position, the pin 78 fills the receiving space 76, which prevents the projections 70 from any further flexing that might otherwise loosen the reveal insert 46 from the through-hole 26. The upper reveal molding 34 is now located along the door frame 14 in a secure manner to allow additional fixed attachment. More specifically, the plurality of spaced apart slots 44 along the upper reveal molding 34 is aligned with the plurality of spaced apart holes 24 along the door frame 14 to receive the fasteners. Thus, the reveal insert 46 effectively simplifies installation of the upper reveal molding 34 to the door frame 14.

In a method of locating the upper reveal molding 34 to the door frame 14, the reveal insert 46 is first coupled to the upper reveal molding 34. The operator secures a portion of the upper reveal molding 34 to the flange 22 of the door frame 14. Next, the operator aligns the plurality of retention fingers 68 of the reveal insert 46 with the through-hole 26 of the door frame 14. Once this alignment is achieved, the operator inserts or pushes the plurality of retention fingers 68 through the through-hole 26. The projections 70 along each of the plurality of retention fingers 68 flex to allow passage thereof. When the secondary end 74 has passed through the through-hole 26, the secondary end 74 of each projection 70 snaps into place against the door frame 14 to establish a locking engagement between the reveal insert 46 and the door frame 14. Finally, the pin 78 is moved from the partially inserted position, shown in FIG. 6, to the fully inserted position, shown in FIG. 7, to fill the receiving space 76 and prevent loosening of the plurality of retention fingers 68 out of the though-hole 26. As a result, the upper reveal molding 34 is located along the door frame 14.

Finally, although the installation assembly has been shown and described with regard to the rear door 12, it is appreciated that the foregoing description including the reveal insert 46 may be utilized to efficiently install an upper reveal molding 34 to a door frame 14 of a front door.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. An upper reveal molding for a motor vehicle door frame having a flange and a through-hole, said upper reveal molding comprising:
a molding strip adapted to be coupled to the flange; and
a reveal insert fixedly secured to said molding strip, said reveal insert including a plurality of retention fingers selectively received within the through-hole and lockingly engageable with the motor vehicle door frame in order to locate said upper reveal molding therealong.

2. An upper reveal molding as set forth in claim 1 wherein said reveal insert includes a mounting portion adapted to be fixedly secured to said molding strip.

3. An upper reveal molding as set forth in claim 2 wherein said reveal insert includes a pin engageable with said plurality of retention fingers for maintaining said plurality of retention fingers in place within the through-hole.

4. An upper reveal molding as set forth in claim 3 wherein said reveal insert includes a tab for aligning said plurality of retention fingers with the through-hole.

5. An upper reveal molding as set forth in claim 4 wherein said reveal insert generates a positive engagement signal upon locking engagement between said plurality of retention fingers and the door frame.

6. A reveal insert as set forth in claim 5 wherein said positive engagement signal is audible.

7. A reveal insert as set forth in claim 5 wherein said positive engagement signal is physical feedback felt by an operator forcing said plurality of retention fingers into engagement with the door frame.

8. A reveal insert for locating an upper reveal molding to a motor vehicle door frame having a through-hole, said reveal insert comprising:
a mounting portion adapted to be coupled to the upper reveal molding; and
a locating portion extending out from said mounting portion, said locating portion including a plurality of retention fingers received within the through-hole and lockingly engageable with the motor vehicle door frame in order to locate the upper reveal molding along the motor vehicle door frame.

9. A reveal insert as set forth in claim 8 wherein each of said plurality of retention fingers includes a projection at a distal end for effecting snap fit engagement with the motor vehicle door frame.

10. A reveal insert as set forth in claim 9 wherein said plurality of retention fingers defines a receiving space therebetween.

11. A reveal insert as set forth in claim 10 wherein said locating portion includes a base plate fixedly secured to one end of each of the plurality of retention fingers and having an aperture aligned with said receiving space.

12. A reveal insert as set forth in claim 11 wherein said locating portion includes a pin extending through said aperture and received within said receiving space.

13. A reveal insert as set forth in claim 12 wherein said locating portion includes a pair of spaced apart outer walls extending out from said base plate opposite said plurality of retention fingers and defining an access space for allowing access to said pin.

14. A reveal insert as set forth in claim 13 wherein said locating portion includes a tab extending out from said base plate for aligning said plurality of retention fingers with the through-hole in the motor vehicle door frame.

15. A reveal insert as set forth in claim 14 wherein said pin includes a leading structure engageable with each of said plurality of retention fingers for maintaining said pin within the entire receiving space.

16. A method for locating an upper reveal molding to a motor vehicle door frame, having a flange and a through-hole, utilizing a reveal insert coupled to the upper reveal molding and having a plurality of retention fingers, the method comprising the steps of:
aligning the plurality of retention fingers of the reveal insert with the through-hole of the motor vehicle door frame;
inserting the plurality of retention fingers through the through-hole of the motor vehicle door frame; and
locking the plurality of retention fingers into engagement with the motor vehicle door frame to locate the upper reveal molding therealong.

17. A method as set forth in claim 16 including the step of securing a portion of the upper reveal molding to the flange.

18. A method as set forth in claim 17 wherein the step of securing a portion of the upper reveal molding to the flange occurs prior to the step of aligning the plurality of retention fingers of the reveal insert to the through-hole of the motor vehicle door frame.

19. A method as set forth in claim 18 wherein the step of aligning the plurality of retention fingers of the reveal insert to the through-hole of the motor vehicle door frame occurs prior to the step of inserting the plurality of retention fingers through the through-hole along the motor vehicle door frame.

20. A method as set forth in claim 19 wherein the step of inserting the plurality of retention fingers through the through-hole of the motor vehicle door frame includes the step of flexing a portion of each of the plurality of retention fingers to allow passage thereof through the through-hole.
